(19) United States
(12) Patent Application Publication
(10) Pub. No.: US 2024/0104787 A1
(43) Pub. Date: Mar. 28, 2024

(54) SOCIALIZING BASED ON PERSONAL PROTECTIVE EQUIPMENT

(71) Applicant: INTERNATIONAL BUSINESS MACHINES CORPORATION, ARMONK, NY (US)

(72) Inventors: Yuan Yuan Ding, Shanghai (CN); Zhong Fang Yuan, Xi'an (CN); Tong Liu, Xi'an (CN); Si Tong Zhao, Beijing (CN); Yi Chen Zhong, Shanghai (CN); Ziqiumin Wang, Shanghai (CN)

(21) Appl. No.: 17/935,242

(22) Filed: Sep. 26, 2022

(51) Int. Cl. G06T 11/00; G06F 40/20

(52) U.S. Cl. CPC G06T 11/00; G06F 40/20

(57) ABSTRACT

Techniques are described with respect to a system, method, and computer product for enhancement of socialization between one or more individuals wearing personal protective equipment. An associated method includes identifying a plurality of social communications between one or more individuals wearing personal protective equipment (PPE) and assigning an identifier to a participant associated with at least one of the social communications. The method further includes analyzing content of the at least one social communication and generating an augmented reality (AR) based representation of the content for presentation on an augmented reality device associated with the user, the augmented reality device presenting the content for visualization replacing PPE based at least in-part on the identifier.

### BACKGROUND

The present invention relates generally to augmented reality. More particularly, the present invention relates to using augmented reality to facilitate socialization in situations where individuals are relying upon personal protective equipment.

As of recent years, personal protective equipment (PPE) has become normalized due to various pandemics. As a result, socializing has been impacted due to the inability to view the full extent of facial expressions when people are wearing PPE. For example, PPE such as face masks presents hurdles to socializing in person due to the inability to view the area below the eyes in addition to the dampening of the person's voice when engaged in conversation.

Furthermore, individuals with disabilities (e.g. deafness, poor eye sight, etc.) are further hindered in communication by face masks due to the limitation of visible facial expressions and lip movements which directly serves as a barrier of communication methods with this demographic.

Modern technology assists in helping individuals overcome these challenges. Augmented reality technology enables enhancement of user perception of a real-world environment through superimposition of a digital overlay in a display interface providing a view of such environment. Augmented reality enables display of digital elements to highlight or otherwise annotate specific features of the physical world. Data collection and analysis may be performed to determine which digital elements to display as the augmented reality. Augmented reality can provide respective visualizations of various layers of information relevant to displayed real-world scenes. In particular, augmented reality may be utilized to display expressions of the aforementioned individuals to those wearing computer-mediated reality (CMR) devices in order to facilitate barrier-free communication methods.

### SUMMARY

Additional aspects and/or advantages will be set forth in part in the description which follows and, in part, will be apparent from the description, or may be learned by practice of the invention.

A system, method, and computer product for enhancement of socialization between one or more individuals wearing personal protective equipment is disclosed herein. In some embodiments, the computer-implemented method for socializing includes identifying a plurality of social communications between one or more individuals wearing personal protective equipment (PPE); assigning an identifier to a participant associated with at least one of the social communications; analyzing content of the at least one social communication; and generating an augmented reality (AR) based representation of the content for presentation on an augmented reality device associated with the user, the augmented reality device presenting the content for visualization replacing PPE based at least in-part on the identifier.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary diagram depicting a visualization system according to at least one embodiment;

FIG. 2 illustrates a functional block diagram illustrating an exemplary socialization computing environment associated with the visualization system of FIG. 1, in accordance with an embodiment of the invention;

FIGS. 3A-B illustrate exemplary personal protective equipment (PPE) views from the perspective of an augmented reality device, in accordance with an embodiment of the present invention; and

FIG. 4 illustrates a flowchart depicting a process for socializing with expression manifestations, according to at least one embodiment;

FIG. 5 depicts a block diagram illustrating components of the software application of FIG. 1, in accordance with an embodiment of the invention;

FIG. 6 depicts a cloud-computing environment, in accordance with an embodiment of the present invention; and

FIG. 7 depicts abstraction model layers, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a method, computer system, and computer program product for facilitation and enhancement of socialization between one or more individuals wearing protective personal equipment. Due to the recent expansion of personal protective equipment being used in public spaces for public health purposes, barriers to forms of communication have emerged. For example, face masks ordinarily cover the nose and mouth area of the wearer, resulting in the full extent of facial expressions not being viewable by participants in a conversation, with facial expressions viewable during conversations being limited to the eye area. In addition, the face mask covering the mouth area also results in the dampening of the wearer's voice requiring them to increase the volume of their voice in order for it to be audible outside of the face mask. Increasing of voice volume, however, may not be suitable for conversations regarding private, sensitive, or confidential matters between parties. As a result, miscommunications and misinterpretations during social communications occur. The AR experience can be used to seamlessly interweave the physical world and a digital element such that the digital element is perceived as an immersive aspect of the physical world/real environment. In this way, augmented reality alters one's ongoing perception of a real-world environment, whereas virtual reality completely replaces the user's real-world environment with a simulated one. Augmented reality is related to two largely synonymous terms: mixed reality and computer-mediated reality. Augmented reality is used to enhance natural environments or situations and offer perceptually enriched experiences. Thus, the present embodiments have the capacity to use augmented reality to provide individuals with mechanisms to circumvent the aforementioned mis-communications and misinterpretations and curtail facial expression limitations caused by integration of PPE into social environments. In particular, the present embodiments utilize mechanisms to depict the facial expressions, sentiments, and other applicable expressions of individuals donning PPE by applying AR technologies that display facial, expressions, sentiments, etc. of the aforementioned individuals on one or more surfaces of applicable PPE viewed by those utilizing the computer-mediated reality (CMR) devices (e.g., computing device 140) in order to facilitate barrier-free communication methods. In addition, the present embodiments directly increase methods of communication for individuals with disabilities (e.g. deaf, Dysarthria, Aphasia, etc.) by providing a means to visibly depict their expressions, sentiments, etc. to individuals using and/or donning CMR devices (e.g. AR glasses, virtual reality computing device, etc.).

The present invention may be a system, a method, and/or a computer program product at any possible technical detail level of integration. The computer program product may include the computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted herein that in the described embodiments, participating parties (i.e., users) have consented to having their images taken, uploaded, modified, augmented, saved recorded, monitored, etc. Additionally, participating parties are aware of the potential that such recording and monitoring may be taking place. In various embodiments, for example, when downloading or operating an embodiment of the present invention, the embodiment of the invention presents a terms and conditions prompt enabling the interested parties to opt-in or opt-out of participation. In other embodiments of the invention, a QR code included on the PPE worn by user indicates whether or not the wearer has consented to utilization of embodiments of the invention.

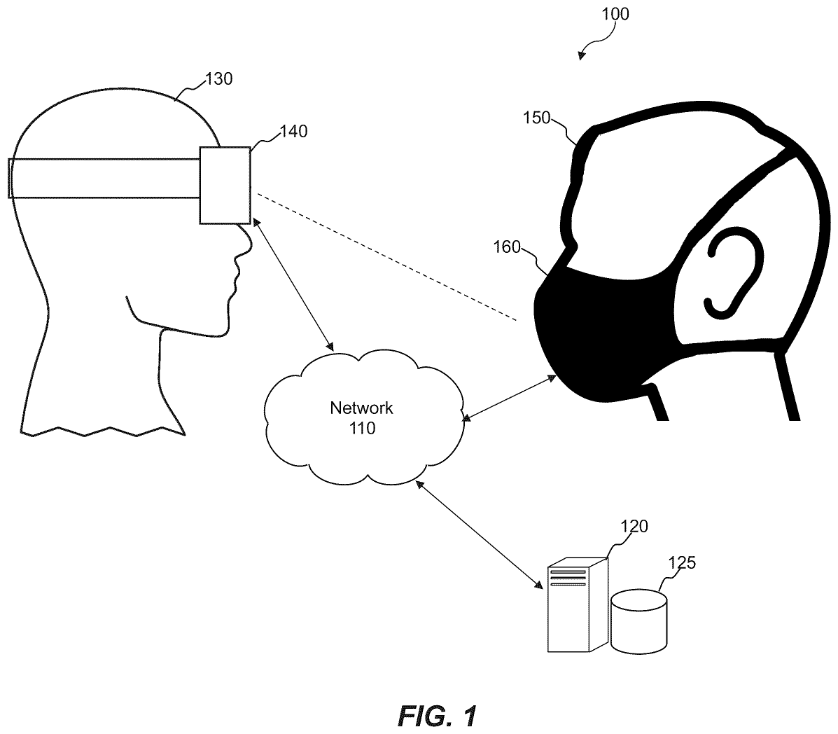

Referring now to FIG. 1, a visualization system 100 configured to support social communications is depicted, according to an exemplary embodiment. As described herein, social communications may include any communications such as ideas, opinions, expressions, etc. between users of visualization system 100 designed to be represented via voice, other audio, text (e.g. messages, writings, digital posts, etc.), graphics, animations, or any other applicable form of media. System 100 includes a server 120 communicatively coupled to a database 125, a user 130 associated with a computing device 140 and user 150 who is wearing personal protective equipment (PPE) 160. Both users 130 and 150 (collectively “participants”) are provided a centralized platform hosted by server 120 for social communications. Each of the aforementioned elements of system 100 are communicatively coupled over a communication network 110. According to at least one implementation, system 100 includes a networked computer environment designed to include a plurality of servers and computing devices such as server 120 and computing device 140, respectively. In system 100, although only one of each disclosed element is shown for illustrative brevity, various embodiments of the presently disclosed invention disclose any number of enumerated elements while being within scope of disclosed embodiments. In a preferred embodiment, computing device 140 is any type of computer-mediated reality (CMR) device such as augmented reality (AR) devices (e.g. smart lens, smart glasses, augmented glasses, AR glasses, head-mounted display, etc.) as depicted in FIG. 1; however, in alternative embodiments, computing device 140 may be a mobile device, a headset, a personal digital assistant, a netbook, a laptop computer, a tablet computer, a desktop computer, internet of things (IoT) device, or any type of computing device capable of executing an AR application such as envisioned by embodiments disclosed herein.

In various embodiments of the invention, communication network 110 may include one or more of various types of communication networks, such as a wide area network (WAN), local area network (LAN), a telecommunication network, a wireless network, a public switched network, and/or a satellite network. The communication network 110 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements. As described in certain embodiments disclosed herein, personal protective equipment (PPE) is personal protective equipment (PPE) includes clothing, face masks, helmets, goggles, or other equipment designed to protect the wearer 150 from a wide variety of hazards, including physical injury, electrocution, heat or chemicals burns, bio-hazard contamination, and airborne particulate matter inhalation but serving to cover at least part of the face of wearer 150 and/or obscure the voice of wearer 150. In some embodiments, PPE 160 may further include one or more electrical and/or computational components communicatively coupled to server 120 over network 110. For illustrative purposes, PPE 160 is depicted throughout as a face mask in which one or more AR based representations/simulations of obscured portions of wearer 150 (hereinafter referred to as “augmented reality content”) are presented on at least one surface of the face mask in a view of user 130 wearing computing device 140. The augmented reality content serves, in various embodiments to display/play to user 130 wearing CMR device 140 details which are “missed” from view and/or audio of user 130 because they are obscured, by example, from the view of. In a preferred embodiment, the AR based simulations are depicted directly on one or more viewable surfaces of PPE 160 in the view of the user 130 using; however, in some alternative or complementary embodiments, PPE 160 includes a liquid crystal display surface, strip, disk, ovaloid, etc. (generically, “display surface”) configured to amplify the depiction of the augmented reality content to other individuals not directly using computing device 140. The display surface may be located on an outside surface of PPE 160 such that the display surface is visible to anyone in view of user 150. Other display surfaces suitable for facial masks, cloth masks, and other applicable PPE embodiments may be accounted in which real-time graphics, animations, and other applicable digital images may be visualized on the display surface. PPE 160 may further include external light emitting diodes (LED), a controller, a communication interface, or any other applicable features known to those of ordinary skill in the art. In some embodiments, PPE 160 includes microcontrollers, processors, sensors, and other applicable components known to those of ordinary skill in the art. In various embodiments, one or more surfaces of PPE 160 may be edited and/or modified visually via the visualization of AR content depicted through computing device 140.

In some embodiments, the PPE 160 may include a microphone which captures audio that is spoken by the person, e.g. user 150, who is wearing the PPE 160. It should be noted that the augmented reality content in various embodiments, is a representation of emotions, sentiments, facial expressions, and other applicable expressions of user 150 to be presented to user. When the digital content is displayed as AR and/or on the PPE 160, the digital content is viewable by user 130 on computing device 140. Computing device 140 defines a virtual space on the display surface The virtual space may be delimited by a spatial border that is created by computing device 140. The spatial border may be visible only to user 130. The virtual space receives the augmented reality content depicting the expressions of user 150 on the display surface or any other applicable surface of PPE 160.

Augmented reality content may further include emojis or emoticons which are icons, pictures, pictograms, etc. expressing an idea, emotion, or expression of user 130. In addition, the augmented reality content includes visual representations of paralanguages such as sign language in order to facilitate the present embodiment to persons with communication disabilities. The centralized platform allows user 150 to determine social communications desired to be conveyed to other parties via the augmented reality content; however, server 120 is configured to automatically (pending permission of user 150) select the augmented reality content to convey social communications based on processing data received by applicable computing devices communicatively coupled to server 120. For example in the instance where user 150 wears a wearable device and/or IoT device communicatively coupled to server 120 and configured to collect biological data of user 150 (e.g. heart rate, physiological data, etc.), server 120 may automatically generate and select augmented reality content reflecting the applicable social communication associated with user 150 based on analyses of the biological data. Biological data may be used by server 120 to analyze the dopamine, oxytocin, serotonin and endorphin levels of user 150 allowing server 120 to ascertain that user 150 is happy and in a good mood, in which augmented reality content will manifest to user 130 (e.g. happy emojis, a smile mask layer, etc.) on the display surface.

A smart phone or smart watch that is worn by the user 150 may also capture audio that is spoken the by the user 150, perform speech-to-text transcription, and transmit some or all of the spoken text to the server 120. Server 120 being communicatively coupled to computing device 140 and PPE 160 over communication network 110 allows users 130 and 150 to be engaged with the community where the social communications are hosted on the centralized platform and users of the community are grouped. The centralized platform allows users 130 and 150 to interact within a virtual community configured to support grouping of users, role assignments, user confirmation security mechanisms, media delivery restrictions (e.g. certain types of content being blocked from certain users), etc. Server 120 generates and assigns a unique identifier for each user within the community allowing users to not only be managed and assigned permissions, but also to verify the identity of users and whether augmented reality content is intended to be generated for viewing on the computing device 140. In addition, the unique identifier may be assigned to a user based on the role of the user within the community (e.g. manager, colleague, etc.). The unique identifier may further be utilized for other various purposes such as selection of the type of augmented reality content generated, permissions as to who is able to view augmented reality content, role of a user within the community, etc. Upon verification that user 130 is an authorized party to receive the augmented reality content associated with user 150 based on the confirmation of unique identifier, server 120 generates instructions for the augmented reality content to be created in which the augmented reality content is augmented onto at least one visible surface of PPE 160. Assigning permissions prevents certain types of augmented reality content from being augmented and viewed by undesired parties wearing AR devices (e.g. parental controlled augmented reality content, confidential augmented reality content, etc.). For example, user 130 may not be allowed to view certain emojis due to the applicable assigned permissions.

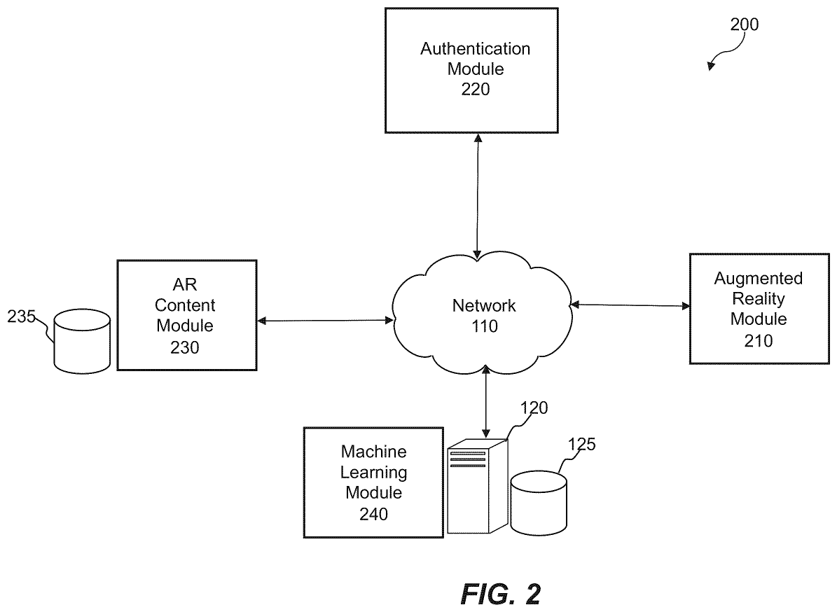

Referring now to FIG. 2, a socialization environment 200 associated with visualization system 100 is depicted, according to an exemplary embodiment. Socialization environment includes an augmented reality (AR) module 210, an authentication module 220, a augmented reality content module 230, a augmented reality content database 235 communicatively coupled to augmented reality content module 230, and a machine learning module 240. Each of the aforementioned modules are communicatively coupled to server 120 over communication network 110. In some embodiments, augmented reality (AR) module 210, authentication module 220, augmented reality content module 230, and machine learning module 240 are components of server 120. Environment 200 may be a distributed data processing environment in which the term “distributed” as used herein describes a computer system that includes multiple, physically distinct devices that operate together as a single computer system. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

Network 110 can include one or more wired and/or wireless networks capable of receiving and transmitting data, voice, and/or video signals, including multimedia signals that include voice, data, video information, etc. AR module 210 is configured to create and maintain a virtual reality (VR), augmented reality (AR), and/or mixed reality environment designed to be viewed from computing device 140. Information pertaining to user 130 operating in the VR/AR environment (e.g. user preferences, personal information, user location, VR/AR environment features, etc.) may be collected from user 130 via computing device 140 and components therein (e.g. sensors, cameras, etc.). Database 125 is configured to store applicable data processed by server 120 and derivatives associated with the VR/AR environment including but not limited to predictions associated with interactions, movements, vision, preferences, etc. of user 130 within the VR/AR environment. In addition, database 125 stores profiles of users of the centralized platform as records.

AR module 210 is configured to be associated with one or more computing devices, which may respectively include, without limitation, smartphones, tablet computers, laptop computers, desktop computers, computer-mediated reality (CMR) devices/VR/AR devices, and/or other applicable hardware/software. AR module 210 may be configured to depict AR environments, virtual reality (“VR”) environments, and/or mixed reality environments. Database 125 contains one or more repositories of data collected, processed, and/or presented within the AR environment including but not limited to motion data (e.g. motion patterns) associated with users, VR/AR environment-based analytics, and any other applicable data associated with virtual reality systems known to those of ordinary skill in the art. In some embodiments, AR module 210 may be configured to operate through a web browser, as a dedicated app or other type of software application running either fully or partially on a computing system.

AR module 210 communicates with augmented reality content module 230 to receive from the augmented reality content module 230 AR based representations of augmented reality content such as animated graphics for display on computing device 140. The augmented reality content includes AR reconstruction simulations that represent the expressions of user 150. The expressions may be provided to the centralized platform by user 150 or ascertained automatically by server 120 based on data collected by PPE 160 or any applicable computing device associated with user 150 (e.g. wearables, IOT devices, smartphones, smart watches, etc.).

Authentication module 220 authorizes user 130 and user 150 in order to ensure not only that the augmented reality content representing the expressions is that of user 150, but also that user 130 is the appropriate viewing party to receive the augmented reality content. In addition, authentication module 220 serves as a security manager for the community in which a plurality of permissions are allocated across users based upon one or more of unique identifiers, relationship between users, content/context associated with augmented reality content, user preferences, etc. Authentication module 220 uses a unique methodology for augmenting authentication mechanisms, such as facial recognition, linking the unique identifiers with the applicable users within the community, and detection of two-dimensional codes allocated one or more surfaces of PPE 160 by the applicable sensors of computing device 140. Authorization of the users within the community verifies that social communications are being sent/received by the appropriate parties, and that confidentiality of the augmented reality content is preserved. Upon authorization by authentication module 220, AR module 210 receives the augmented reality content from augmented reality content module 230 and generates an AR simulation including the augmented reality content displayed on computing device 140. In a preferred embodiment, the AR simulation is presented overlaid on the display surface of PPE 160 in which the AR simulation is developed based on data collected by computing device 140 (e.g. location data, image data, etc.). For example, a sensor of computing device 140 detects a QR code allocated on PPE 160 which triggers AR module 210 to define the virtual space on the display surface and to present the AR simulation within the virtual space upon authentication module 220 verifying user 130 and user 150.

Augmented reality content module 230 generates the AR simulation configured to be presented within the virtual space. Augmented reality content module 230 may store augmented reality content in augmented reality content database 235. Augmented reality content may be accessed based on the unique identifier associated with the applicable user of the community. In some embodiments, augmented reality content may be modified based on one or more of server 120, user 130, computing device 140, user 150, PPE 160. For example, user 150 may be attempting to express that they are depressed and in response the server 120 automatically selects an emoji reflecting a sad/somber mood. AR module 210 receives the emoji from augmented reality content module 230 for inclusion within the AR simulation. As a result, the emoji is viewable on the display surface of PPE 160 by user 130 on computing device 140 including user viewing preferences, AR depiction constraints designated by AR module 210 (e.g. location data, detected 3D assets, etc.), or any other applicable data configured to optimize the presentation of the AR simulation.

Machine learning module 240 is configured to use one or more heuristics and/or machine learning models for performing one or more of the various aspects as described herein. In some embodiments, the machine learning models may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. AR module 210 can analyze the surrounding area of computing device 140 and utilize machine learning module 240 to predict, using one or more machine learning models trained on historical events (e.g. depictions of AR simulations received by computing device 140), what happened in the physical event area (e.g. display surface of PPE 160). For example, the one or more machine learning models that may be used to model the sequences of events (e.g. optimal dimensions of previous AR simulations, etc.) and predict precursor events including Markov models, reinforcement learning (RL), recurrent neural network, sequence mining model, and/or time series model. In addition, machine learning module 240 may use one or more machine learning models trained on data collected by one or more of server 120, PPE 160, or applicable computing devices associated with user 150 (e.g. wearables, IOT devices, etc.) to generate predictions pertaining to expressions of user 150. For example, biological sensors of PPE 160 or applicable computing devices (e.g. electromyography sensors) communicatively coupled to server 120 collect biological data (e.g. muscular movements, blood pressure readings, heartrate, etc.) for training datasets in order for the one or more machine learning models to generate predictions pertaining to the expressions, sentiments, etc. of user 150. Server 120 utilizes the predictions to instruct augmented reality content module 230 to generate augmented reality content based on the predictions that reflect the applicable expressions, sentiments, etc. of user 150. For example, collected biological data indicating high blood pressure, fatigue, and lack of sleep allows machine learning module 240 to predict that user 150 is stressed, and in response the augmented reality content module 230 generates the stressed emoji for inclusion in the AR simulation. Predictions and other applicable outputs of machine learning module 240 are configured to be stored in database 125.

It should be noted that the community designed to host social communications is further configured to support grouping of users based upon one or more of unique identifiers, relationships between users (e.g. family, friends, colleagues, etc.), permissions allocated by authentication module 220, etc. In some embodiments, server 120 provides one or more user interfaces to computing device 140 and other applicable computing devices allowing users to modify permissions allocated by authentication module 220 via the centralized platform. In addition, users of the community with disabilities may provide social communications (e.g. posts, sentiments, etc.) to the centralized platform allowing augmented reality content module 230 to generate augmented reality content manifesting the social communications, which are presented to computing device 140 via the AR simulations. For example, user 150 generates a social communication including the message “I'm hungry” by inputting the social communication on a user interface derived from the centralized platform, and in response the social communication is identified and analyzed by server 120 and sent to machine learning module 240. The social communication is manifested as augmented reality content generated by augmented reality content module 230 including the text of the social communication. Machine learning module 240 processes the social communication to ascertain the sentiment associated with the social communication in instances in which the sentiment has not been provided to the centralized platform. In some embodiments, machine learning module 240 utilizes natural language processing (NLP) to ascertain one or more sentiments used to define an expression of user 150 by converting a social communication in the form of an audio input received by an applicable sensor to text, which is configured to be manifested as a visible text message within the AR simulation generated by AR content module 230.

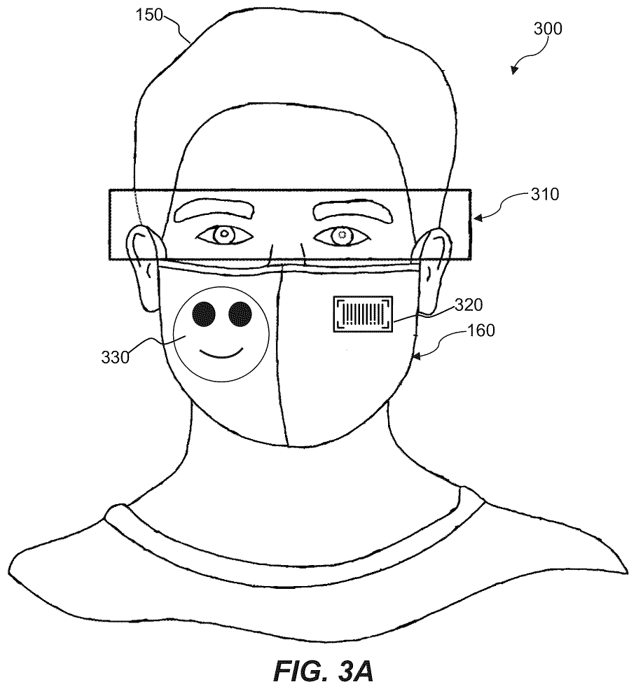

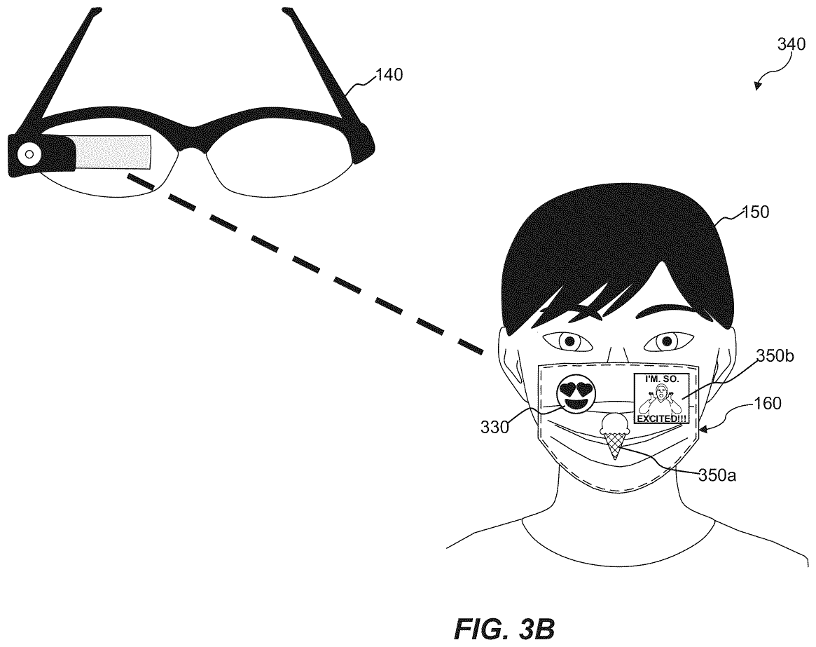

Referring now to FIGS. 3A-B, a first example 300 of PPE 160 is depicted, according to an exemplary embodiment. Example 300 includes user 150 wearing PPE 160 which is depicted as a face mask in this particular embodiment. The view in example is a possible visualization of computing device 140 being presented the AR simulation via AR module 210. Area 310 (also referred to as “the first portion of the face”) depicts the uncovered portion of the face of user 150 which is not included in the virtual space defined by AR module 210; however in some embodiments, computing device 140 may capture an image of area 310 for transmission to server 120 over network 110 in order for authentication module 220 to verify user 150 based on area 310 (e.g. retinal/eye detection and analysis, face structure analysis, edge detection, difference values, etc.) and the unique identifier associated with user 150. PPE 160 may include a data processing system designed to be communicatively coupled to server 120 over network 110. The data processing system is configured to detect and analyze the contextual situation (e.g. cultural context, location/neighborhood, time-of-the day, etc.) of user 150 and generate contextual alerts with a risk level (e.g. low, medium, high). This may include directly measuring activity using integrated acceleration sensors in the data processing system, collecting a time series of locations using an integrated global positioning system receiver in the data processing system, accessing the calendar of user 150, determining a level of privacy with user 130 given computing device 140 establishing a connection and evaluating the surrounding area, etc. In some embodiments, PPE 160 includes PPE identifier 320 which is linked to the plurality of permissions maintained by authentication module 220. The computing device 140 detecting PPE identifier 320 may be the triggering action that initiates authentication module 220 to verify user 130. PPE identifier 320 may be a QR code, barcode, RFID, or any other applicable detectable identifier known to those of ordinary skill in the art. PPE identifier 320 is linked to the applicable user of the community (e.g. user 150) via the unique identifier and may be utilized for identification purposes, security purposes, confirmation of user permissions, tailoring of AR content, etc. Upon computing device 140 detecting PPE identifier 320 not only does authentication module 220 verify that user 130 possesses the applicable permissions to view the AR simulation including AR based representation of AR content 330, but also AR content module 230 may tailor AR content 330 based on the permissions and applicable configurations of computing device 140. For example, the expressions of user 150 may include sensitive content that requires privacy within a public setting. Due to the required privacy, AR content module 230 may generate AR content 330 in a modified version. For example, the modified content may include audio content that is derived from AR content 330. The audio content may be played only for authorized for user 130. The modified content alternatively and/or additionally may include a redacted version of AR content 330 where it is ascertainable what user 150 is trying to convey; however, one or more components of AR content 330 are redacted and/or overlayed. For example, if user 150 is unavailable to communicate due to currently being on a mobile device and unable to convey this to user 130, then AR content 330 may include a visual depiction of a “Do Not Disturb” message. In some embodiments, analysis of area 310 based on the unique identifier serves as an increased layer of security for authentication module 220 to verify user 150. As depicted in example 300, AR content 330 is an emoji including a happy sentiment associated with user 150; however, AR content 330 may be any applicable visual depiction and/or auditory emitting of animations, texts, audio, combinations thereof, etc. of the expressions of user 150 that are capable of being manifested. When user 130 looks at PPE 160 in search of PPE identifier 320, computing device 140 is analyzing the surrounding area of user 130 in order to ascertain the context of the environment and whether the environment is deemed appropriate (e.g. whether the environment requires privacy) given the content of AR content 330.

A second example 340 is depicted in FIG. 3B including user 150 wearing PPE 160 which is depicted as a face mask in this particular embodiment. It should be noted that example 340 shows the view of user 130 who is looking in the direction of user 150 and PPE 160 through the computing device 140 shown as an AR device (e.g. AR goggles). In addition to user 130 being able to view a positive or excited expression of user 160, user 130 may further view expressions of user 150 derived from AR content 330 generated by AR content module 230 in real-time. For example, in the instance in which user 130 and user 150 are having a dialogue user 130 may say to user 150 “Do you want to get ice cream?”, in which AR content module 230 generates AR content 330 but also analyzes both the statement made by user 150 and AR content 330 in order to generate expressions 350a and 350b reflecting elements, sentiments, etc. of AR content 330. In this particular example, expression 350a represents an ice cream icon and expression 350b reflects the sentiment associated with 350a. As presented, PPE 160 intentionally does not include PPE identifier 320, in which depiction of AR content 330 through computing device 140 is subject to authentication module 220 performing authentication unilaterally for user 130 and AR content module 230 generating AR content 330 based on credentials, permissions, roles, etc. associated with user 130 and their relationship with other users within the community.

In some embodiments, data collected by computing device 140 and the data processing system of PPE 160 may be transmitted to machine learning module 240 over network 110 allowing machine learning module 240 to generate predictions pertaining to risk levels, privacy levels, expression sentiments, etc. based on the collected data. For example, machine learning module 240 may generate one or more predictions indicating that the current environment is not appropriate for AR content 330 to be included in the AR simulation due to the expression relating to user 150 being depressed and the environment including multiple other individuals that said expression is not intended for.

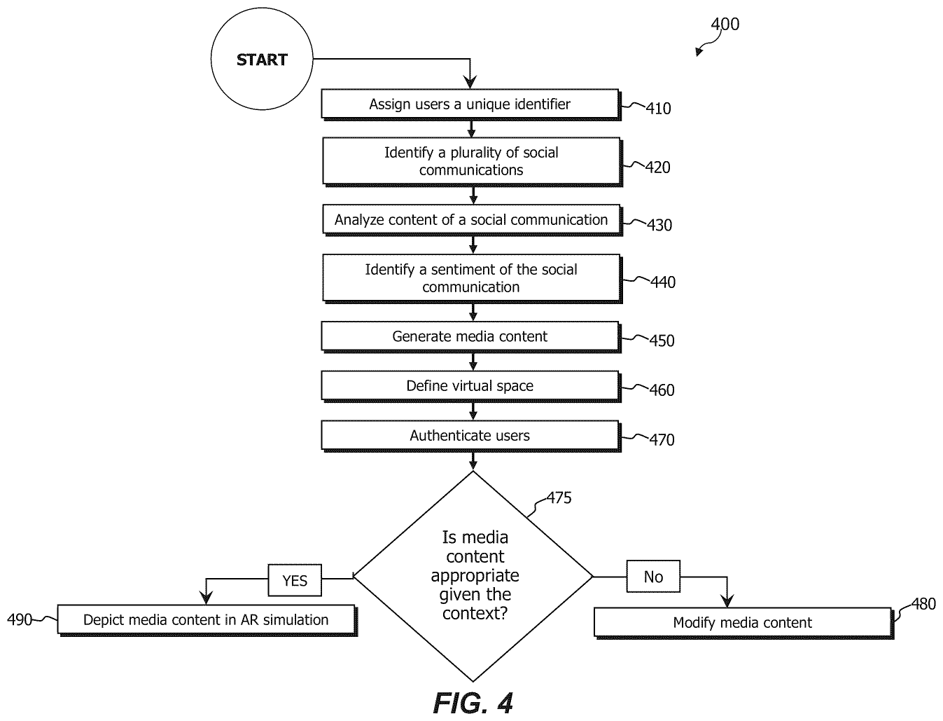

With the foregoing overview of the example architecture, it may be helpful now to consider a high-level discussion of an example process. FIG. 4 depicts a flowchart illustrating a computer-implemented process 400 for socializing with expression manifestations, consistent with an illustrative embodiment. Process 400 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 410 of process 400, server 120 assigns a unique identifier to each user of the community hosted by the centralized platform. The centralized platform is configured to support grouping of users, messaging and other applicable social communications among users (e.g. texts, chats, videocalls, etc.), role assignments (e.g. visible roles, invisible roles, etc.), AR content customization. In some embodiments, AR content module 230 generates the AR content based upon the unique identifier and the role assigned to user 130. For example, AR content 330 as depicted in FIG. 3 may be the default AR content displayed within the AR simulation in the instances in which user 130 has the assigned role as a “stranger”; however, in the instances in which user 130 has an assigned role of “family” or “friend” then AR content 330 may be a more detailed expression (e.g. excited emoji, relevant audio, animations, etc.). The unique identifier not only serves as a means to distinguish users within the community, but also as a mechanism for authentication module 220 to verify users. In some embodiments, each user of the community includes a user profile associated with their unique identifier. The profile may be stored in database 125 and may be accessed by the unique identifier. Each social communication identified on the centralized platform is associated with the applicable users involved in the social communication based on the unique identifier.

At step 420 of process 400, server 120 receives and identifies a plurality of social communications on the centralized platform. It should be noted that the plurality of social communications may be received via text inputs, audio inputs, and/or any other applicable type of input configured to be received by computing devices known to those of ordinary skill in the art. As social communications are being identified by server 120, machine learning module 240 is utilizing natural language processing to convert applicable audio inputs into text not only for transmission to AR content module 230, but also to assist with optimizing training data sets used for the analyzing of the social communications which are accumulated during iterations of the machine learning models.

At step 430 of process 400, server 120 analyzes the content of the identified social communications. In some embodiments, the natural language processing of the identified social communications results in the conversion of audio into text which allows for the tokenizing, lexical analyses, semantic relationships identification, syntactic relationships identification, sentiment detection, etc. Server 120 may further utilize ontology building to construct social communication ontology in order to ascertain expressions, sentiments, etc. of social communications associated with user 150. It should be noted that the ascertained sentiments may be used to define the expressions that will be included in the AR content generated by AR content module 230.

At step 440 of process 400, server 120 identifies a sentiment of an identified social communication. Server 120 may be communicatively coupled to a sentiment identifier configured to identify a variety of sentiments by analyzing different types of data representative of an expression, sentiment, emotional state, or activity of user 150. For example, the sentiment identifier can receive verbal expressions (e.g. from an audio sensor of an applicable computing device associated with user 150), such as words spoken by user 150 and/or a transcript of those spoken words derived from natural language processing, may determine a meaning of the words, and then may identify a sentiment based on the determined meaning. The sentiment identifier may further receive non-verbal and/or paralanguage expressions (e.g. from the applicable audio sensor, from a visual sensor and/or a motion sensor of the applicable computing device associated with user 150 that detects actions and a physical presence of user 150), including expressions indicated using signals other than words, such as facial expressions, posture, gestures, sign language, appearance, personal space, foot movements, hand movements, etc. Such non-verbal sentiments can include, but are not limited to, body language (kinesics), distance (proxemics), physical environment and appearance, voice (paralanguage), touch (haptics), timing (chronemics), and oculesics (e.g. eye contact, looking while talking, frequency of glances, patterns of fixation, pupil dilation, blink rate, etc.). Such paralanguage expressions can include, but are not limited to, voice quality, rate, pitch, volume, mood, and speaking style, as well as prosodic features such as rhythm, intonation, and stress. The sentiment identified/determined via the sentiment identifier may take into account such non-verbal and/or paralanguage expressions in addition to the verbal expressions. In some embodiments, the sentiment identifier may also obtain a biological data feed from the biological sensor of PPE 160 or applicable computing devices, such as a sensor in a wearable device/IOT device, monitoring a physical condition (e.g. blood pressure, heart rate, temperature, etc.) or a physical activity (e.g. walking, sitting, dancing from a pedometer, etc.) of user 150. In some embodiments, machine learning module 240 identifies features of activities, expressions, and other actions received by PPE 160 or applicable computing device associate with user 150 and assigns those features values indicative of a sentiment state.

At step 450 of process 400, AR content module 230 generates the AR content based on one or more analyses of the social communications such as the sentiment identified in step 440. The AR content that is generated may be a manifestation of one or more expressions of user 150. The AR content may be generated based on the context/content of the expressions, the role assigned to user 130 and/or user 150, the permissions allocated to the unique identifier, user preferences provided to the centralized platform, configurations of computing device 140, or any other applicable factor utilized for rendering AR content. The one or more expressions in the AR based representation are designed to actively reflect the sentiments of user 150 in a continuous manner due AR content module 230 integrating them in the AR content. In some embodiments, AR content module 230 may translate the expressions of the AR content into a language different from the original language of the social communication. Such translation allows the AR content to bridge communication gaps caused by language barriers. The translation may be based upon the language preference of user 130 who is the receiving party of the AR content. It should be noted that the AR content is generated based on the analyses of the content of social communications of user 150 in order to manifest the expressions, sentiments, etc. of user 150 within the AR simulation.

At step 460 of process 400, AR module 210 defines a virtual space for which the AR simulation will be depicted. AR module 210 creates and maintains a virtual reality (VR), augmented reality (AR), and/or mixed reality environment designed to be viewed from computing device 140. In a preferred embodiment, AR module 210 defines the virtual space on the display surface, where the virtual space is delimited by a spatial border that is created by computing device 140, and where the spatial border is visible only to user 130 on computing device 140. The virtual space receives the AR simulation including AR content depicting the expressions of user 150 on the display surface or any other applicable surface of PPE 160. In some embodiments, the defining of the virtual space is based upon one or more of user preferences, configurations of computing device 140/AR module 210, etc.

At step 470 of process 400, authentication module 220 verifies user 130 and user 150. In some embodiments, when user 130 performs an authentication triggering action in the form of an applicable sensor of computing device 140 detecting PPE identifier 320, authentication module 220 verifies unique identifiers of user 130 and user 150. For example, computing device 140 transmits an image of area 310 of user 150 and PPE identifier 320 to server 120 over network 110 in order for authentication module 220 to verify user 150 based on analyses of the eyers of user 150, the unique identifier of user 150, and PPE identifier 320. It is not necessarily required that user 130 is verified by authentication module 220 due to the fact that computing device 140 may depict a default VR simulation, and AR module 210 may integrate the AR content into the VR simulation upon analyzing the plurality of permissions and the roles assigned to both user 130 and user 150.

At step 475 of process 400, the data processing system of PPE 160 and computing device 140 communicate with server 120 in order for server 120 to determine the context of the environment of which AR module 210 desires to depict the AR content within the VR simulation and determines if the AR content is appropriate given the context. For example, if computing device 140 analyzes the environment surrounding PPE 160 and detects multiple individuals within close proximity of user 130 and user 150, then server 120 determines that the context of the environment in which AR content would otherwise be presented is currently an invasion of privacy or confidentiality. As a result, step 480 of process 400 occurs in which AR content generated by AR content module 230 is rendered in a modified form (e.g. visual components of the AR content presented without audio, redacted versions of the AR content, etc.) and depicted by AR module 210 in the AR simulation presented to be shown overlaid over the applicable display surface of PPE 160. Otherwise, step 490 of process 400 occurs in which AR module 210 embeds the AR content generated by AR content module 230 into visualizations for PPE 160 resulting in manifestations of the expressions of user 150 into a AR simulation overlaid over the display surface of PPE 160 solely for viewing of user 130 via computing device 140. In some embodiments, the visualization replaces PPE 160 and/or one or more components of PPE 160 via the depiction of the AR simulation through computing device 140. In which, the visualization makes it appear that the AR content has replaced PPE 160 with the AR content being depicted based on the unique identifier.

The details and embodiments disclosed herein are provided by way of example and should not be construed as limiting the scope of the disclosed subject matter to the particular details or specific embodiments. Certain implementations may provide or apply the disclosed concepts and processes, with some variations, to VR/AR system, VR/AR platform, or CMR devices, whether location-based or not.

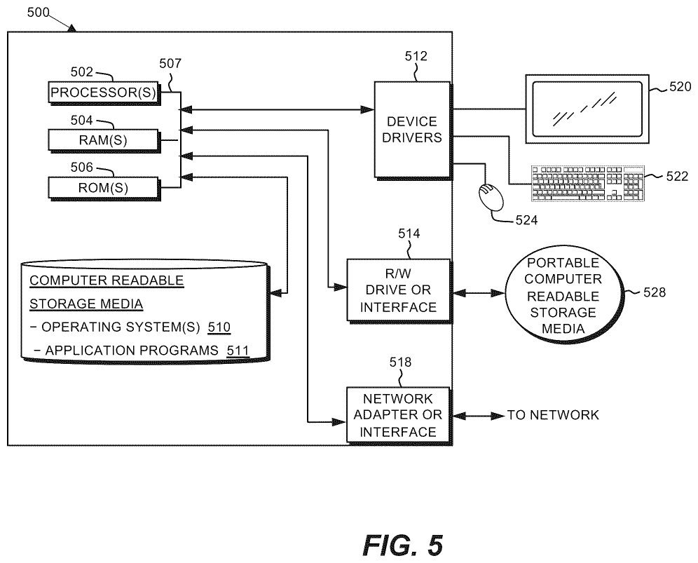

FIG. 5 is a block diagram of components 500 of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 500 is representative of any electronic device capable of executing machine-readable program instructions. Data processing system 500 may be representative of a smart phone, a computer system, PDA, or other electronic devices. Examples of computing systems, environments, and/or configurations that may represented by data processing system 500 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices. The one or more servers may include respective sets of components illustrated in FIG. 5. Each of the sets of components include one or more processors 502, one or more computer-readable RAMs 504 and one or more computer-readable ROMs 506 on one or more buses 507, and one or more operating systems 510 and one or more computer-readable tangible storage devices. The one or more operating systems 510 may be stored on one or more computer-readable tangible storage devices 516 for execution by one or more processors 502 via one or more RAMs 508 (which typically include cache memory). In the embodiment illustrated in FIG. 5, each of the computer-readable tangible storage devices 516 is a magnetic disk storage device of an internal hard drive. Alternatively, each of the computer-readable tangible storage devices is a semiconductor storage device such as ROM 506, EPROM, flash memory or any other computer-readable tangible storage device that can store a computer program and digital information.

Each set of components 500 also includes a RAY drive or interface 514 to read from and write to one or more portable computer-readable tangible storage devices 528 such as a CD-ROM, DVD, memory stick, magnetic tape, magnetic disk, optical disk or semiconductor storage device. A software program can be stored on one or more of the respective portable computer-readable tangible storage devices 528, read via the respective RAY drive or interface 514 and loaded into the respective hard drive.

Each set of components 500 may also include network adapters (or switch port cards) or interfaces 518 such as a TCP/IP adapter cards, wireless wi-fi interface cards, or 3G or 4G wireless interface cards or other wired or wireless communication links. Applicable software can be downloaded from an external computer (e.g. server) via a network (for example, the Internet, a local area network or other, wide area network) and respective network adapters or interfaces 518. From the network adapters (or switch port adaptors) or interfaces 518, the centralized platform is loaded into the respective hard drive. The network may comprise copper wires, optical fibers, wireless transmission, routers, firewalls, switches, gateway computers and/or edge servers.

Each of components 500 can include a computer display monitor 520, a keyboard 522, and a computer mouse 524. Components 500 can also include touch screens, virtual keyboards, touch pads, pointing devices, and other human interface devices. Each of the sets of components 500 also includes device drivers 512 to interface to computer display monitor 520, keyboard 522 and computer mouse 524. The device drivers 512, R/W drive or interface 514 and network adapter or interface 518 comprise hardware and software (stored in RAM 504 and/or ROM 506).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g. mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g. country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g. storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g. web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g. host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g. mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g. cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

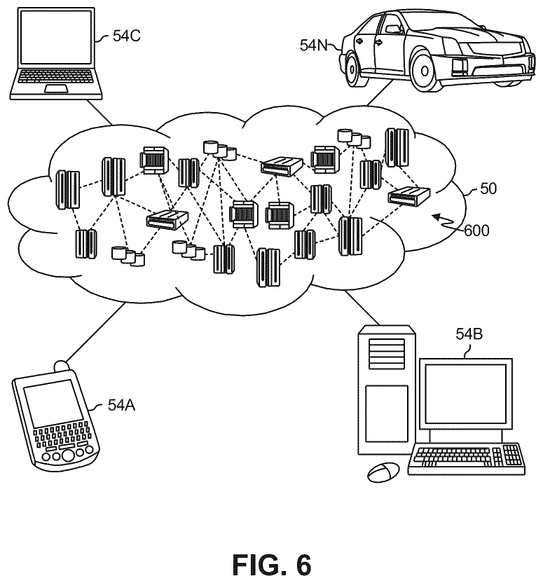

Referring now to FIG. 6, illustrative cloud computing environment 600 is depicted. As shown, cloud computing environment 600 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 54A-N shown in FIG. 6 are intended to be illustrative only and that computing nodes 50 and cloud computing environment 600 can communicate with any type of computerized device over any type of network and/or network addressable connection (e.g. using a web browser).

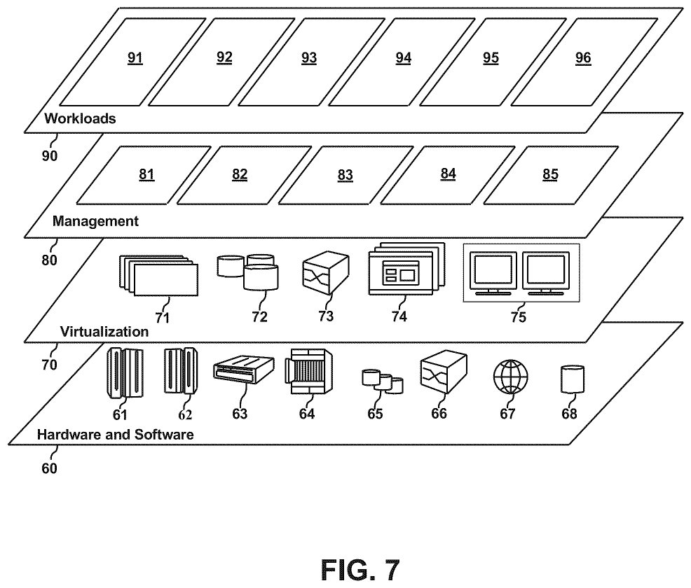

Referring now to FIG. 7 a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and AR expression generation 96. AR expression generation 96 relate to generating AR representations of AR content including one or more expressions of user 150.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for enhancement of socialization between one or more individuals wearing personal protective equipment, the method comprising:
identifying, by a computing device, a plurality of social communications between one or more individuals wearing personal protective equipment (PPE);
assigning, by the computing device, an identifier to a participant associated with at least one of the social communications;
analyzing, by the computing device, content of the at least one social communication; and
generating, by the computing device, an augmented reality (AR) based representation of the content for presentation on an augmented reality device associated with the user, the augmented reality device presenting the content for visualization replacing PPE based at least in-part on the identifier.

2. The computer-implemented method of claim 1, wherein generating the AR based representation further comprises:
determining, by the computing device, whether a QR code on the PPE worn by the participant is associated with the identifier; and
responsive to determining the QR code is associated with the identifier, depicting, by the computing device, the AR based representation of the content for presentation to the augmented reality device associated with the user.

3. The computer-implemented method of claim 1, wherein analyzing the content comprises:
applying, by the computing device, natural language processing (NLP) to the content to determine a sentiment of the content; and
defining, by the computing device, one or more expressions based on the sentiment;
wherein generating the AR based representation of the content comprises:
including, by the computing device, the one or more expressions in the AR based representation.

4. The computer-implemented method of claim 1, wherein the identifier is associated with a role assigned to the participant on a centralized platform hosting the plurality of social communications.

5. The computer-implemented method of claim 4, wherein assigning the identifier further comprises:
grouping, by the computing device, a plurality of participants associated with the plurality of social communications based on the role;
wherein at least one participant of the plurality of participants dons the PPE.

6. The computer-implemented method of claim 3, wherein generating the AR based representation further comprises:
continuously integrating, by the computing device, the one or more expressions in the AR based representation to actively reflect the sentiment of the participant;
wherein the one or more expressions are derived from utilizing machine learning prediction models for sentiments of the participant.

7. The computer-implemented method of claim 1, wherein the PPE is selected from the group comprising a face mask, helmet, clothing, and goggles communicatively coupled to the computing device.

8. A computer system for socializing, the computer system comprising:
one or more processors, one or more computer-readable memories, and program instructions stored on at least one of the one or more computer-readable memories for execution by at least one of the one or more processors to cause the computer system to:
program instructions to identify a plurality of social communications between one or more individuals wearing personal protective equipment (PPE);
program instructions to assign an identifier to a participant associated with at least one of the social communications;
program instructions analyze content of the at least one social communication; and
program instructions generate an augmented reality (AR) based representation of the content for presentation on an augmented reality device associated with the user, the augmented reality device presenting the content for visualization replacing PPE based at least in-part on the identifier.

9. The computer system of claim 8, wherein the program instructions to generate the AR based representation further comprise:
program instructions to determine whether a QR code on the PPE worn by the participant is associated with the identifier; and
program instructions to depict the AR based representation of the content for presentation to the augmented reality device associated with the user responsive to the determination the QR code is associated with the identifier.

10. The computer system of claim 8, wherein the program instructions to generate the AR based representation further comprise:
program instructions to determine whether a QR code on the PPE worn by the participant is associated with the identifier; and
program instructions to depict the AR based representation of the content for presentation to the augmented reality device associated with the user responsive to the determination the QR code is associated with the identifier.

11. The computer system of claim 8, wherein the program instructions to analyze content further comprise:
program instructions to apply natural language processing (NLP) to the content to determine a sentiment of the content;
program instructions to define one or more expressions based on the sentiment;
wherein program instructions to generate the AR based representation of the content further comprise:
program instructions to include the one or more expressions in the AR based representation.

12. The computer system of claim 8, wherein the identifier is associated with a role assigned to the participant on a centralized platform hosting the plurality of social communications.

13. The computer system of claim 12, wherein the program instructions to assign the identifier further comprise:
program instructions to group a plurality of participants associated with the plurality of social communications based on the role;
wherein at least one participant of the plurality of participants dons the PPE.

14. The computer system of claim 10, wherein the program instructions to generate the AR based representation further comprise:
program instructions to continuously integrate the one or more expressions in the AR based representation to actively reflect the sentiment of the participant;
wherein the one or more expressions are derived from utilizing machine learning prediction models for sentiments of the participant.

15. A computer program product for socializing, the computer program product comprising a computer readable storage medium having program instructions embodied therewith, wherein the computer readable storage medium is not a transitory signal per se, the program instructions being executable by a processor to cause the processor to perform a method comprising:
identifying a plurality of social communications between one or more individuals wearing personal protective equipment (PPE);
assigning an identifier to a participant associated with at least one of the social communications;
analyzing content of the at least one social communication; and
generating an augmented reality (AR) based representation of the content for presentation on an augmented reality device associated with the user, the augmented reality device presenting the content for visualization replacing PPE based at least in-part on the identifier.

16. The computer program product of claim 15, wherein generating the AR based representation further comprises:
determining whether a QR code on the PPE worn by the participant is associated with the identifier; and
responsive to determining the QR code is associated with the identifier, depicting the AR based representation of the content for presentation to the augmented reality device associated with the user.

17. The computer program product of claim 15, wherein analyzing the content comprises:
applying natural language processing (NLP) to the content to determine a sentiment of the content; and
defining one or more expressions based on the sentiment;
wherein generating the AR based representation of the content comprises:
including the one or more expressions in the AR based representation.

18. The computer program product of claim 15, wherein the identifier is associated with a role assigned to the participant on a centralized platform hosting the plurality of social communications.

19. The computer program product of claim 15, wherein generating the AR based representation further comprises:
continuously integrating the one or more expressions in the AR based representation to actively reflect the sentiment of the participant;
wherein the one or more expressions are derived from utilizing machine learning prediction models for sentiments of the participant.

20. The computer program product of claim 18, wherein the PPE is selected from the group comprising a face mask, helmet, clothing, and goggles communicatively coupled to the centralized platform.
